(19) United States
(12) Patent Application Publication
(10) Pub. No.: US 2019/0042089 A1
(43) Pub. Date: Feb. 7, 2019

(54) METHOD OF IMPROVED DATA DISTRIBUTION AMONG STORAGE DEVICES

(71) Applicant: Intel Corporation, Santa Clara, CA (US)

(72) Inventors: Anjaneya R. CHAGAM REDDY, Chandler, AZ (US); Mohan J. KUMAR, Aloha, OR (US); Sujoy SEN, Beaverton, OR (US); Murugasamy K. NACHIMUTHU, Beaverton, OR (US); Gamil CAIN, El Dorado Hills, CA (US)

(21) Appl. No.: 15/910,933

(22) Filed: Mar. 2, 2018

(51) Int. Cl. G06F 3/06

(52) U.S. Cl. CPC G06F 3/0604; G06F 3/067; G06F 3/0653

(57) ABSTRACT

Examples include techniques for determining a storage policy for storing data in a computing system having one or more storage nodes, each storage node including one or more storage devices. One technique includes getting rating information from a storage device of a storage node; assigning the storage device to a storage pool based at least in part on the rating information; and automatically determining a storage policy for the computing system based at least in part on the assigned storage pool and the rating information.

### TECHNICAL FIELD

Examples described herein are generally related to techniques for improving performance of storing and accessing data in storage devices in computing systems.

### BACKGROUND

A storage device includes one or more types of memory. A multi-level cell (MLC) is a memory element capable of storing more than a single bit of information, compared to a single-level cell (SLC) which can store only one bit per memory element. Triple-level cells (TLC) and quad-level cells (QLC) are versions of MLC memory, which can store 3 and 4 bits per cell, respectively. (Note that due to convention, the name “multi-level cell” is sometimes used specifically to refer to the “two-level cell”). Overall, memories are commonly referred to as SLC (1 bit per cell—fastest, highest cost); MLC (2 bits per cell); TLC (3 bits per cell); and QLC (4 bits per cell—slowest, least cost). One example of a MLC memory is QLC NAND flash memory.

Some computing systems use different types of storage devices to store data objects depending on the sizes of the data objects, the frequencies of access of the data objects, the desired access times, and so on. Some computing systems may include one or more storage nodes, with each storage node including one or more storage devices. A computing system may have storage devices of various types of memory, with various operating characteristics and capabilities. In some computing systems, hashing techniques are used to provide a deterministic way to distribute and locate data objects across the entire set of storage nodes in a computing system. One known hashing algorithm uses relative weights of storage nodes to identify how data objects are to be distributed evenly in a cluster of storage nodes without creating hot spots.

Data center administrators currently use command line tools at a system console to identify types of storage devices, group storage devices into logical pools, and manually assign weights based on documented storage device specifications. This manual storage setup (in some cases implemented as customized command line scripts) is based on known reference configurations to automate storage node weights for consistent hashing during a storage pool provisioning step.

The solutions used currently are manual and error prone due to a lack of a clear way to assign weights to storage nodes in the storage pool based on storage device properties. Further, storage device specifications may not be available, or may be incorrect or outdated, which makes this information an unreliable source for assessing storage device performance. A data center administrator typically runs a few synthetic (e.g., artificial or contrived) benchmarks to identify storage device performance characteristics and then manually assigns weights for the storage devices and storage nodes. Given the increasingly large number of storage devices in modern computer server farms, this approach is problematic.

### BRIEF DESCRIPTION OF THE DRAWINGS

FIG. 1 illustrates an example computing system.

FIG. 2 illustrates an example storage node.

FIG. 3 illustrates an example server computing system.

FIG. 4 illustrates an example of getting a storage device rating.

FIG. 5 illustrates an example of a logic flow of a storage management operation.

FIG. 6 illustrates an example of a logic flow of assigning a storage device to a pool.

FIG. 7 illustrates an example storage medium.

### DETAILED DESCRIPTION

As contemplated in the present disclosure, a storage device may expose performance characteristics information (e.g., rating information) which gets used by a storage management component to determine a storage management policy for a computing system. In an embodiment, the storage management policy may be based on automated memory grouping (also calling pooling or tiering) and assigned relative weights based on the storage device performance characteristics information to improve on hashing-based data distribution within a computing system.

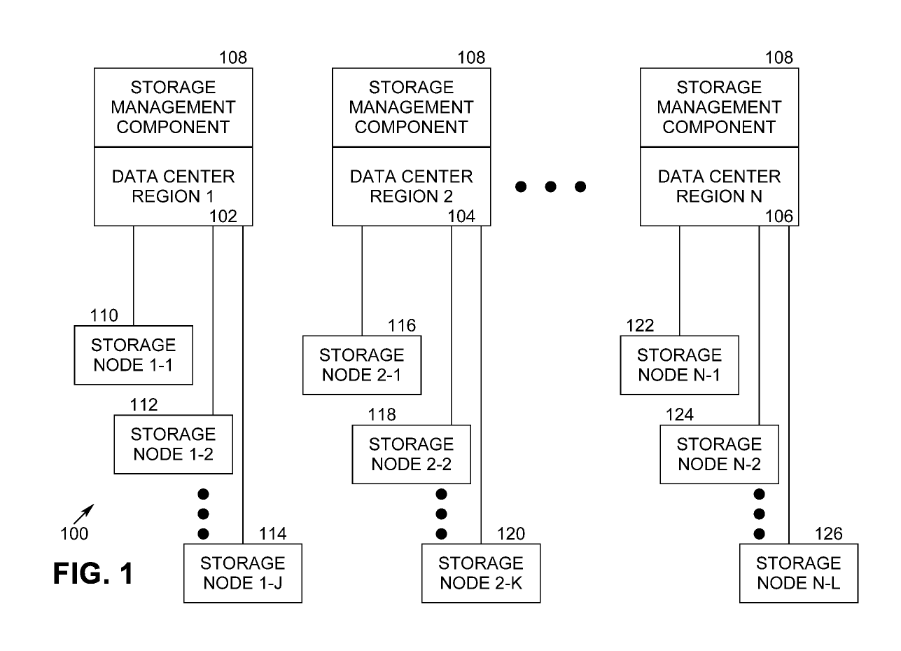

FIG. 1 illustrates an example computing system. Computing system 100 includes one or more data center regions, such as data center region 1 102, data center region 2 104, . . . data center region N 106, where N is a natural number. Each data center region in computing system 100 includes at least one storage management component 108. In embodiments of the present invention, storage management component 108 obtains performance characteristics information from storage devices in the data center region and determines one or more storage device weight values for each storage device. Storage management component 108 determines a storage node weight value for each storage node based at least in part on the storage device weight values of the storage devices belonging to the storage node. Storage management component determines a storage management policy for the data center regions in the computing system based at least in part on the storage node weight values and the storage device weight values. Storage management component 108 may use the determined storage device weight values to group storage devices into storage pools. Computing system 100 may then use the storage management policy when determining where to store data in the computing system.

Each data center region in computing system 100 may include one or more storage nodes. For example, data center region 1 102 includes “J” number of storage nodes, denoted storage node 1-1 110, storage node 1-2 112, . . . storage node 1-J 114, where J is a natural number. For example, data center region 2 104 includes “K” number of storage nodes, denoted storage node 2-1 116, storage node 2-2 118, . . . storage node 2-K 120, where K is a natural number. For example, data center region N 106 includes “L” number of storage nodes, denoted storage node N-1 122, storage node N-2 124, . . . storage node N-L 120, where L is a natural number.

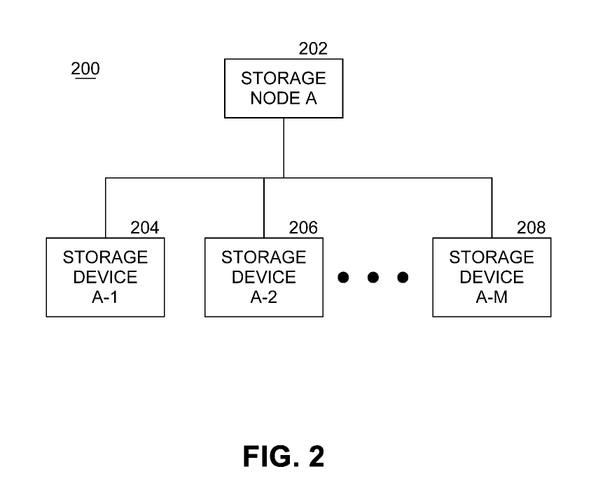

FIG. 2 illustrates an example storage node. Storage node 200 may be representative of any storage node shown in FIG. 1. For example, storage node A 202 may include one or more storage devices as shown, such as storage device A-1 204, storage device A-2 206, . . . storage device A-M 208, where M is a natural number.

Thus, in some examples, depending on the overall storage requirements for computing system 100, the computing system may include many storage nodes, with each storage node possibly including many storage devices. Further, each storage device may include one or more memories. Each storage device 204, 206, . . . 208 may have performance characteristics information that is discoverable by storage management component 108.

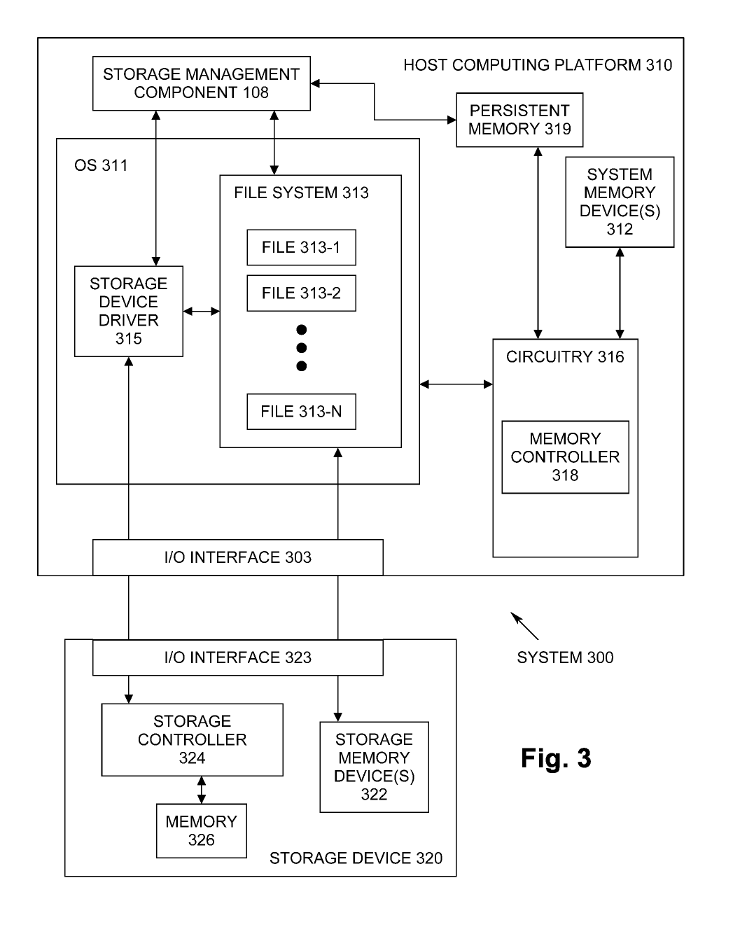

FIG. 3 illustrates an example server computing system 300 in a data center region. In some examples, as shown in FIG. 3, system 300 includes a server 310 coupled to one or more storage devices 320 through I/O interface 303 and I/O interface 323. Storage device 320 is representative of any one or more of storage device A-1 204, storage device A-2 206, to storage device A-M 208 of FIG. 2. As shown in FIG. 3, server 310 may include an operating system (OS) 311, one or more system memory device(s) 312, circuitry 316 and storage management component 108. For these examples, circuitry 316 may be capable of executing various functional elements of server 310 such as OS 311 and storage management component 108 that may be maintained, at least in part, within system memory device(s) 312. Circuitry 316 may include host processing circuitry to include one or more central processing units (CPUs) (not shown) and associated chipsets and/or controllers.

According to some examples, as shown in FIG. 3, OS 311 may include file system 313 and one or more storage device drivers 315, and one or more storage devices 320 may include a storage controller 324, one or more storage memory device(s) 322 and memory 326. OS 311 may be arranged to implement storage device driver 315 to coordinate at least temporary storage of data for a file from among files 313-1 to 313-n, where “n” is any whole positive integer >1, to storage memory device(s) 322. The data, for example, may have originated from or may be associated with executing at least portions of OS 311 or application programs (not shown in FIG. 3). As described in more detail below, OS 311 communicates one or more commands and transactions with storage device 320 to write data to or read data from storage device 320. The commands and transactions may be organized and processed by logic and/or features at storage device 320 to write the data to or read data from storage device 320.

In some examples, storage controller 324 may include logic and/or features to receive transaction requests to storage memory device(s) 322 at storage device 320. For these examples, the transaction requests may be initiated by or sourced from OS 311 that may, in some embodiments, utilize file system 313 to write/read data to/from storage device 320 through input/output (I/O) interfaces 303 and 323.

In some examples, memory 326 may include volatile types of memory including, but not limited to, RAM, D-RAM, DDR SDRAM, SRAM, T-RAM or Z-RAM. One example of volatile memory includes DRAM, or some variant such as SDRAM. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, memory 326 may include non-volatile types of memory, whose state is determinate even if power is interrupted to memory 326. In some examples, memory 326 may include non-volatile types of memory that is a block addressable, such as for NAND or NOR technologies. Thus, memory 326 can also include a future generation of types of non-volatile memory, such as a 3-dimensional cross-point memory (3D XPoint™ commercially available from Intel Corporation), or other byte addressable non-volatile types of memory. According to some examples, memory 126 may include types of non-volatile memory that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

In some examples, storage memory device(s) 322 may be a device to store data from write transactions and/or write operations. Storage memory device(s) 322 may include one or more chips or dies having gates that may individually include one or more types of non-volatile memory to include, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM. For these examples, storage device 320 may be arranged or configured as a solid-state drive (SSD). The data may be read and written in blocks and a mapping or location information for the blocks may be kept in memory 326.

According to some examples, communications between storage device driver 315 and storage controller 324 for data stored in storage memory devices(s) 322 and accessed via files 313-1 to 313-n may be routed through I/O interface 303 and I/O interface 323. I/O interfaces 303 and 323 may be arranged as a Serial Advanced Technology Attachment (SATA) interface to couple elements of server 310 to storage device 320. In another example, I/O interfaces 303 and 323 may be arranged as a Serial Attached Small Computer System Interface (SCSI) (or simply SAS) interface to couple elements of server 310 to storage device 320. In another example, I/O interfaces 303 and 323 may be arranged as a Peripheral Component Interconnect Express (PCIe) interface to couple elements of server 310 to storage device 320. In another example, I/O interfaces 303 and 323 may be arranged as a Non-Volatile Memory Express (NVMe) interface to couple elements of server 310 to storage device 320. For this other example, communication protocols may be utilized to communicate through I/O interfaces 303 and 323 as described in industry standards or specifications (including progenies or variants) such as the Peripheral Component Interconnect (PCI) Express Base Specification, revision 3.1, published in November 2014 (“PCI Express specification” or “PCIe specification”) or later revisions, and/or the Non-Volatile Memory Express (NVMe) Specification, revision 1.2, also published in November 2014 (“NVMe specification”) or later revisions.

In some examples, system memory device(s) 312 may store information and commands which may be used by circuitry 316 for processing information. Also, as shown in FIG. 3, circuitry 316 may include a memory controller 318. Memory controller 318 may be arranged to control access to data at least temporarily stored at system memory device(s) 312 for eventual storage to storage memory device(s) 322 at storage device 320.

In some examples, storage device driver 315 may include logic and/or features to forward commands associated with one or more read or write transactions and/or read or write operations originating from OS 311. For example, the storage device driver 315 may forward commands associated with write transactions such that data may be caused to be stored to storage memory device(s) 322 at storage device 320.

System Memory device(s) 312 may include one or more chips or dies having volatile types of memory such RAM, D-RAM, DDR SDRAM, SRAM, T-RAM or Z-RAM. However, examples are not limited in this manner, and in some instances, system memory device(s) 312 may include non-volatile types of memory, including, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM.

Persistent memory 319 may include one or more chips or dies having non-volatile types of memory, including, but not limited to, NAND flash memory, NOR flash memory, 3-D cross-point memory (3D XPoint™), ferroelectric memory, SONOS memory, ferroelectric polymer memory, FeTRAM, FeRAM, ovonic memory, nanowire, EEPROM, phase change memory, memristors or STT-MRAM.

According to some examples, server 310 may include, but is not limited to, a server, a server array or server farm, a web server, a network server, an Internet server, a work station, a mini-computer, a main frame computer, a supercomputer, a network appliance, a web appliance, a distributed computing system, a personal computer, a tablet computer, a smart phone, multiprocessor systems, processor-based systems, or combination thereof, in a data center region.

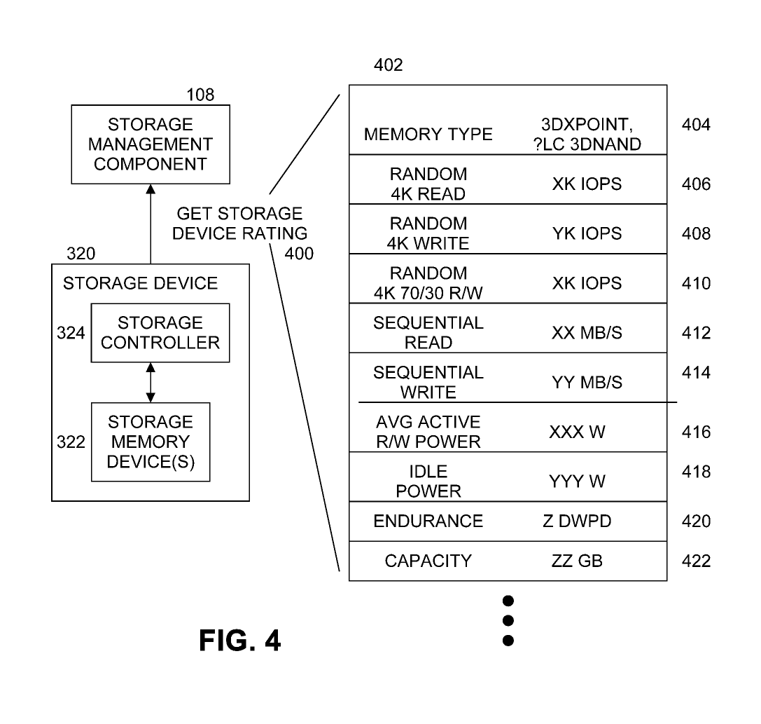

FIG. 4 illustrates an example of getting a storage device rating. In an embodiment, when storage device 320 supports the NVMe specification, storage management component 108 may send a command to storage controller 324 within storage device 320 to obtain performance characteristics information 402 about the storage device. In an embodiment, performance characteristics information may also be known as a storage device rating, or rating information. In an embodiment, the command may be a Get Storage Device Rating command 400, or a similar command. In other embodiments, other storage device specifications and associated commands may be used. In one example as shown in FIG. 4, performance characteristics information 402 may include one or more data fields. The data fields that may be included in performance characteristics information 402 may depend on many factors, such as the type of storage device, including the storage device's memory type, version number, I/O capabilities, storage capacity, power usage, access speed, and so on. For example, performance characteristics information 402 may include a memory type field 404, which may specify which type of memory is present in the storage device (e.g., 3D XPoint™, SLC NAND, MLC NAND, TLC NAND, QLC NAND, 3D NAND, and so on). For example, performance characteristics information 402 may include a random 4K read field 406, which may specify a performance rating for a random 100% read of 4K bits from the storage device in terms of input/output (IO) per second (IOPS). For example, performance characteristics information 402 may include a random 4K write field 408, which may specify a performance rating for a random 100% write of 4K bits to the storage device in terms of input/output (IO) per second (IOPS). For example, performance characteristics information 402 may include a random 4K 70/30 field 4010, which may specify a performance rating for a random access of a block having 4K bits with 70% reads from and 30% writes to the storage device in terms of input/output (IO) per second (IOPS). For example, performance characteristics information 402 may include a sequential read field 412, which may specify a performance rating for a sequential read from the storage device in terms of megabytes per second (MB/S). For example, performance characteristics information 402 may include a sequential write field 414, which may specify a performance rating for a sequential write to the storage device in terms of megabytes per second (MB/S). For example, performance characteristics information 402 may include an average active read/write (R/W) power field 416, which may specify an average power consumption of the storage device in terms of watts. For example, performance characteristics information 402 may include an idle power field 418, which may specify a performance rating an idle power consumption of the storage device in terms of watts. For example, performance characteristics information 402 may include an endurance field 420, which may specify a how may drive writes per day (DWPD) the storage device is expected to perform without failure. For example, performance characteristics information 402 may include a capacity field 422, which may specify the size of the memory in the storage device in terms of gigabytes (GBs)

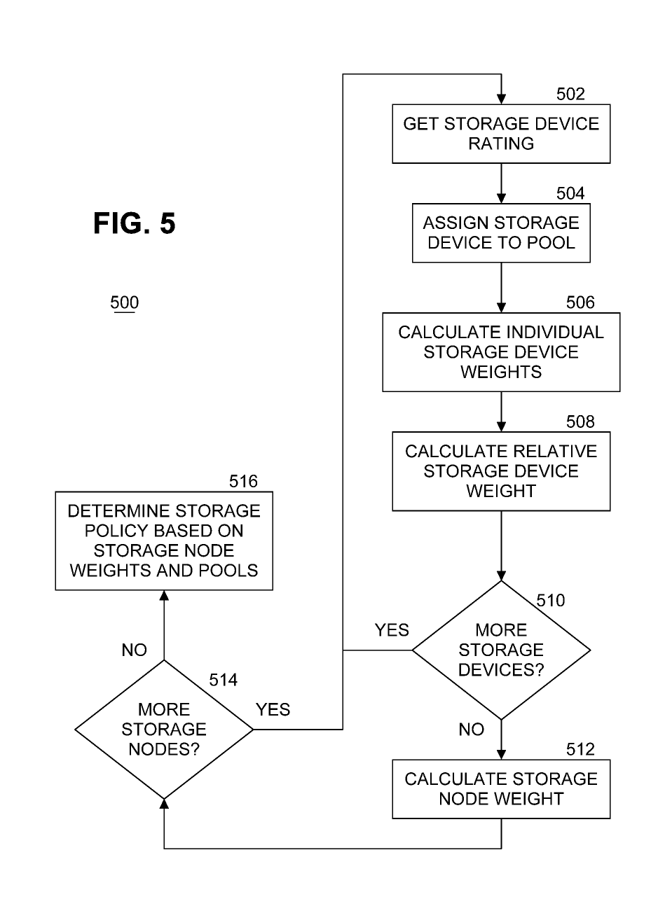

FIG. 5 illustrates a logic flow of a storage management operation. For these examples, these processes may be implemented by or use components or elements of system 300 shown in FIG. 3 such as storage management component 108, OS 311, circuitry 316, persistent memory 319, system memory device(s) 312, storage device 320, storage controller 324, memory 326, and/or storage memory device(s) 322. However, this process is not limited to being implemented by or use only these components or elements of system 300. Logic flow 500 may be representative of some or all of the operations executed by one or more logic, features, or devices described herein.

In an embodiment, flow 500 may be implemented in storage management component 108 of system 100 shown in FIG. 1, or storage management component 108 of system 300 of FIG. 3. In another embodiment, flow 500 may be implemented in circuitry 316 of system 300 shown in FIG. 3. In an example, storage management component 108 may be arranged to execute one or more software or firmware implemented components or modules

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

Storage management component 108 may be executed to automatically determine a storage policy for system 100, taking into account characteristics and performance ratings of one or more storage nodes in the system, and one or more storage devices in each storage node. The storage policy may be used by system 100 to make decisions for allocating data to be stored in the storage node(s), and a storage device(s) within a storage node, that may be best suited for overall system performance. In an embodiment, storage management component 108 may be executed upon startup of system 100. In an embodiment, storage management component 108 may be executed on demand (e.g., manually) by a system administrator or may be scheduled to be executed periodically. In another embodiment, storage management component 108 may be executed whenever a storage node is activated or deactivated in the system. In another embodiment, storage management component 108 may be executed whenever a storage device is activated or deactivated in the system. In an embodiment, storage management component 108 may automatically determine the storage policy based on an analysis of one or more storage devices in one or more storage nodes of system 100.

Prior to processing the storage nodes and their storage devices, storage management component 108 may initialize variables to be used in further calculations. In an embodiment, storage management component 108 may initialize a IOPS Denominator, a Throughput Denominator, a Capacity Denominator, a IOPS Relative Weight, a Capacity Relative Weight, and a Throughput Relative Weight. Processing may begin with a first storage device within a first storage node of system 100 at block 502. Storage management component 108 may get the storage device rating for the storage device. At block 504, storage management component 108 may assign the storage device to a storage pool. In an embodiment, a storage pool may be a group or collection of storage devices that have similar operating characteristics.

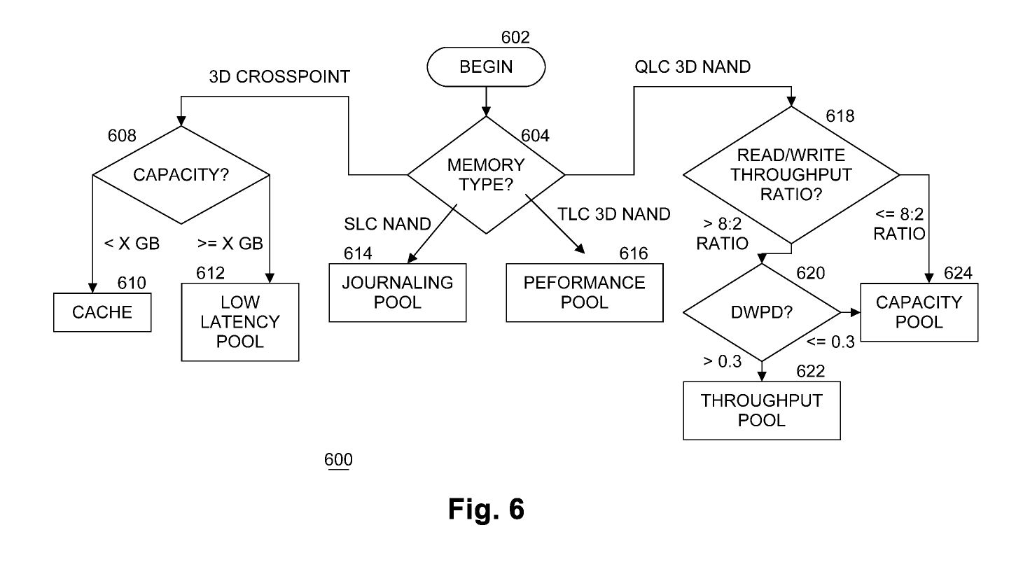

FIG. 6 illustrates an example of a logic flow of assigning a storage device to a storage pool. The type of memory may be used to segregate whether a storage device is meant for workloads requiring better performance or better throughput. Processing may begin at block 602. At block 604 storage management component 108 determines the memory type of the one or more memories in the storage device. If the memory type is 3-D cross-point memory (3D XPoint™), then at block 608 a determination of the capacity of the memory may be made. If the memory of the storage device is less than a predefined threshold (as measured in a number of gigabytes (GBs), such as <X GBs), then the storage device may be assigned to cache pool 610. Cache pool 610 may be used for highest performance accesses and most frequent accesses to data, but the cache pool may be smaller and more expensive. If the memory of the storage device is greater than or equal to the predefined threshold (e.g., >=X GBs), then the storage device may be assigned to low latency pool 612. Low latency pool may be used for highest performance accesses (e.g., those requiring a low latency) and frequent accesses to data, but the low latency pool may be larger than the cache pool. Since the low latency pool is larger than the cache pool, the low latency pool may be more expensive than the cache pool.

If the memory type at block 604 is SLC NAND, then the storage device may be assigned to journaling pool 614. In an embodiment, the journaling pool may be used to store log files of changes to data. Because SLC NAND is used, a higher level of NAND performance with high endurance, but with lower cost than 3-D cross-point, may be provided for the journaling pool. In an embodiment, updates to the data in the journaling pool may be write intensive. If the memory type at block is TLC 3D NAND, then the storage device may be assigned to performance pool 616. Performance pool may be used for performance-oriented workloads that do not have extremely low latency requirements. If the memory type at block 604 is QLC 3D NAND, in an embodiment storage management component 108 may check the read/write throughput ratio of the storage device at block 618. A QLC 3D NAND may provide lower endurance and lower write bandwidth performance that SLC NAND or TLC 3D NAND, but at higher capacity and lower cost. In an embodiment, the read/write throughput ratio may be obtained by performing the Get storage drive rating command. In one embodiment, if the ratio is greater than a predefined value such as 8:2, then storage management component 108 may check the drive writes per day (DWPD) endurance metric for the storage device. In an embodiment, the DPWD metric may be obtained by performing the Get storage drive rating command. In an embodiment, if the DWPD of the storage device is greater than a predefined value such as 0.3, then the storage device may be assigned to throughput pool 622. In an embodiment, throughput pool 622 may be used to store, for example, streaming data, for applications that require higher writes per day. In an embodiment, if the DWPD of the storage device is less than or equal to a predefined value such as 0.3 or is less than or equal to a predefined read/write throughput ratio such as 8:2, then storage device may be assigned to capacity pool 624. In an embodiment, capacity pool 624 may be used to store, for example, data to be archived for longer periods of time with less frequent access.

Although six different storage pool types are shown in FIG. 6, in other embodiments other pool types may also be used. For example, a storage pool may be defined for low power applications. In another example, a storage pool may be defined for high security applications. In an embodiment, a system administrator may override the storage pool programmatically assigned to a storage device and assign the storage device manually to another storage pool.

Turning back now to FIG. 5, processing continues with block 506, where storage management component 108 may calculate individual storage device weights for the storage device based at least in part on the storage device rating information. In an embodiment, the following individual storage device weights may be calculated:

Drive IOPS Weight=Drive IOPS/IOPS Denominator;

Drive Capacity Weight=Drive Capacity/Capacity Denominator;

Throughput Weight=Drive Throughput/Throughput Denominator; wherein the values for Drive IOPS, Drive Capacity, and Drive Throughput may be obtained from the storage device.

In other embodiments, other or additional individual storage device weights may be used.

Next, at block 508 storage management component 108 may calculate a relative storage device weight based at least in part on the individual storage device weights. In an embodiment, the relative storage device weight may be calculated:

Relative Storage Device Weight=(IOPS Relative Weight*Drive IOPS Weight)+(Capacity Relative Weight*Drive Capacity Weight)+(Throughput Relative Weight*Throughput Weight).

At block 510, storage management component 108 determines if more storage devices for the current storage node need to be processed. If so, processing continues at block 502 with the next storage device for the current storage node. If not, processing continues with block 512, where a storage node weight may be calculated at least in part on the relative storage device weights. In an embodiment, the storage node weight represents the aggregated weight of the storage devices of that storage node. In an embodiment, the storage node weight may be calculated as:

Storage Node Weight=ΣRelative Storage Device Weights

At block 514, storage management component 108 determines if more storage nodes need to be processed. If so, processing continues with the first storage device of the next storage node in system 100 at block 502. If not, all storage devices in all storage nodes have now been processed. At block 516, storage management component 108 may automatically determine a storage policy for system 100 based at least in part on the storage node weight for each storage node and the pools. The storage policy may be determined without manual intervention or activation by a system administrator. The storage policy may be used by system 100 to automatically determine which storage nodes and storage devices within storage nodes are to be used for storing data.

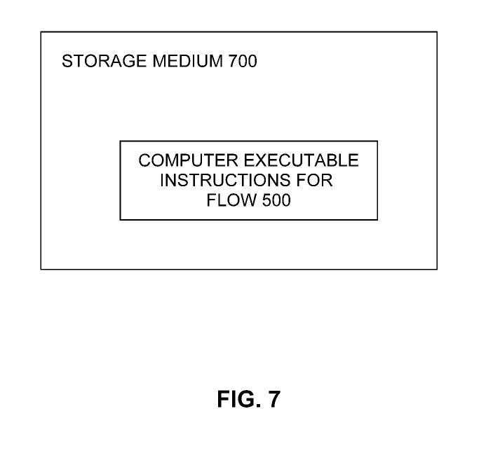

FIG. 7 illustrates an example of a storage medium. The storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flows described above. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

According to some examples, a component called circuitry 316 of FIG. 3 may execute processing operations or logic for storage management component 108 and/or storage medium 700. Circuitry 316 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, programmable logic devices (PLD), digital signal processors (DSP), FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Server 310 may be part of a computing device that may be, for example, user equipment, a computer, a personal computer (PC), a desktop computer, a laptop computer, a notebook computer, a netbook computer, a tablet, a smart phone, embedded electronics, a gaming console, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of server 310 described herein, may be included or omitted in various embodiments of server 310, as suitably desired.

The components and features of server 310 may be implemented using any combination of discrete circuitry, ASICs, logic gates and/or single chip architectures. Further, the features of server 310 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. In a computing system including one or more storage nodes, each storage node including one or more storage devices, a method comprising:
getting rating information from a storage device of a storage node;
assigning the storage device to a storage pool based at least in part on the rating information; and
automatically determining a storage policy for the computing system based at least in part on the assigned storage pool and the rating information.

2. The method of claim 1, comprising:
calculating individual storage weights for the storage device based at least in part on the rating information of the storage device.

3. The method of claim 2, comprising:
calculating relative storage weights for the storage device based at least in part on the individual storage weights.

4. The method of claim 3, comprising:
calculating a storage node weight for the storage node based at least in part on the relative storage device weights.

5. The method of claim 4, comprising automatically determining a storage policy for the computing system based at least in part on the assigned storage pool and the storage node weight.

6. The method of claim 5, wherein the storage node weight comprises a sum of the relative storage device weights of storage devices of the storage node.

7. The method of claim 1, comprising automatically determining, according to the storage policy, which storage nodes and storage devices within storage nodes are used for storing data.

8. The method of claim 1, wherein a type of the storage pool comprises one of a cache pool, a low latency pool, a journaling pool, a performance pool, a throughput pool, and a capacity pool.

9. The method of claim 1, wherein assigning the storage device to the storage pool comprises assigning the storage device to the storage pool based at least in part on a type of memory in the storage device.

10. At least one machine readable medium comprising a plurality of instructions that in response to being executed by a system at a computing platform, the computing platform including one or more storage nodes, each storage node including one or more storage devices, cause the system to:
get rating information from a storage device of a storage node;
assign the storage device to a storage pool based at least in part on the rating information; and
automatically determine a storage policy for the computing system based at least in part on the assigned storage pool and the rating information.

11. The at least one machine readable medium of claim 10, comprising instructions to:
calculate individual storage weights for the storage device based at least in part on the rating information of the storage device.

12. The at least one machine readable medium of claim 11, comprising instructions to:
calculate relative storage weights for the storage device based at least in part on the individual storage weights.

13. The at least one machine readable medium of claim 12, comprising instructions to:
calculate a storage node weight for the storage node based at least in part on the relative storage device weights.

14. The at least one machine readable medium of claim 13, comprising instructions to automatically determine a storage policy for the computing system based at least in part on the assigned storage pool and the storage node weight.

15. The at least one machine readable medium of claim 14, wherein the storage node weight comprises a sum of the relative storage device weights of storage devices of the storage node.

16. The at least one machine readable medium of claim 10, comprising instructions to automatically determine, according to the storage policy, which storage nodes and storage devices within storage nodes are used for storing data.

17. The at least one machine readable medium of claim 10, wherein a type of the storage pool comprises one of a cache pool, a low latency pool, a journaling pool, a performance pool, a throughput pool, and a capacity pool.

18. The at least one machine readable medium of claim 10, wherein instructions to assign the storage device to the storage pool comprises instructions to assign the storage device to the storage pool based at least in part on a type of memory in the storage device.

19. An apparatus comprising:
circuitry; and
logic for execution by the circuitry to: get rating information from a storage device of a storage node; assign the storage device to a storage pool based at least in part on the rating information; and automatically determine a storage policy for the computing system based at least in part on the assigned storage pool and the rating information.

20. The apparatus of claim 19, comprising the logic to calculate individual storage weights for the storage device based at least in part on the rating information of the storage device.

21. The apparatus of claim 20, comprising the logic to calculate relative storage weights for the storage device based at least in part on the individual storage weights.

22. The apparatus of claim 21, comprising the logic to calculate a storage node weight for the storage node based at least in part on the relative storage device weights.

23. The apparatus of claim 22, comprising the logic to automatically determine a storage policy for the computing system based at least in part on the assigned storage pool and the storage node weight.

24. The apparatus of claim 19, wherein a type of the storage pool comprises one of a cache pool, a low latency pool, a journaling pool, a performance pool, a throughput pool, and a capacity pool.

25. The apparatus of claim 19, wherein the logic to assign the storage device to the storage pool comprises logic to assign the storage device to the storage pool based at least in part on a type of memory in the storage device.

26. A system comprising:
one or more storage nodes, each storage node including one or more storage devices;
a server coupled to the one or more storage nodes, the server including a storage management component to get rating information from a storage device of a storage node; assign the storage device to a storage pool based at least in part on the rating information; and automatically determine a storage policy for the computing system based at least in part on the assigned storage pool and the rating information.

27. The system of claim 26, comprising the storage management component to calculate individual storage weights for each storage device based at least in part on the rating information of the storage device.

28. The system of claim 27, comprising the storage management component to calculate relative storage weights for each storage device based at least in part on the individual storage weights of each storage device.

29. The system of claim 28, comprising the storage management component to calculate a storage node weight for each storage node based at least in part on the relative storage device weights of storage devices in the storage node.

30. The system of claim 29, comprising the storage management component to automatically determine a storage policy for the system based at least in part on the assigned storage pool and the storage node weight.
